(19) United States
(12) Patent Application Publication
(10) Pub. No.: US 2018/0290404 A1
(43) Pub. Date: Oct. 11, 2018

(54) APPLICATION OF HSM PROCESS IN WING MOLDING AND WING MOLDING METHOD

(71) Applicant: XIAMEN HOWER MATERIAL CO., LTD., Xiamen City (CN)

(72) Inventors: JinYun CAI, Xiamen City (CN); BuLong LI, Xiamen City (CN); RongQuan XIE, Xiamen City (CN); WeiPing LI, Xiamen City (CN)

(21) Appl. No.: 16/004,974

(22) Filed: Jun. 11, 2018

Related U.S. Application Data
(63) Continuation of application No. PCT/CN2017/075373, filed on Mar. 2, 2017.

(30) Foreign Application Priority Data
Jan. 22, 2017 (CN) 201710053124.X

(51) Int. Cl. B29C 70/44; B29C 70/54

(52) U.S. Cl. CPC B29C 70/44; B29L 2031/3085; B29C 70/545

(57) ABSTRACT

The disclosure discloses an application of an HSM (Heat Self Molding) process in wing molding and a wing molding method. Specific application steps include: cutting a core-type thermal expansion compound, a cladding-type thermal expansion compound and a fiber pre-preg fabric according to the shape and dimensions of a wing; cladding the core-type thermal expansion compound with the cladding-type thermal expansion compound, then cladding the fiber pre-preg fabric on the cladding-type thermal expansion compound; placing a pre-formed product in a wing die, closing a die cover, and heating the die, wherein a thermal expansion HSM compound is molded by the effect of a heating program while the fiber pre-preg fabric is cured at a high temperature, and then wing molding is completed; cooling the die, opening the die, and taking out the wing. A light and smooth wing product with high strength and a streamlined shape is obtained. The cost is reduced, and continuous batch production is feasible, thus greatly improving the productivity.

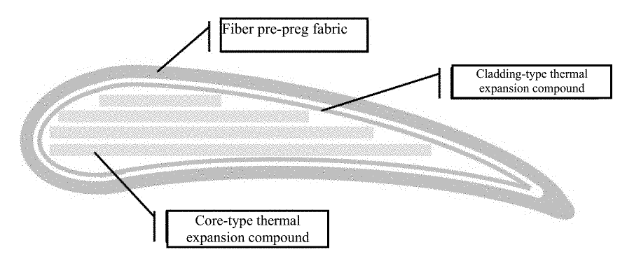

### CROSS-REFERENCE TO RELATED APPLICATIONS

This application is a Bypass Continuation of International Application No. PCT/CN2017/075373, filed Mar. 2, 2017, which claims the benefit of Chinese Patent Application No. 201710053124.X, filed Jan. 22, 2017, all of which are hereby incorporated by reference as if fully set forth herein.

### BACKGROUND OF THE DISCLOSURE

### Technical Field

The disclosure relates to the field of fiber composite molding, in particular to an application of an HSM (Heat Self Molding) process in wing molding and a wing molding method.

### Description of Related Art

Wings have a main function of generating a lift force to support a plane which flies through the air, and also play a certain stabilizing and manipulating role. Wings are essential parts of a plane. The wings are not symmetric; the top of each one of the wings is curved, while the bottom is relatively flat. In accordance with the basic principle of fluid dynamics, the atmosphere which flows slowly has a relatively large pressure, while the atmosphere which flows fast has a relatively small pressure. Thus, the pressure on a lower surface of each one of the wings is higher than the pressure on an upper surface. In other words, the pressure (upward) applied by the atmosphere onto the lower surface of each one of the wings is larger than the pressure (downward) applied to the upper surface of each one of the wings, and the difference between the two pressures forms the lift force of the plane.

At present, traditional fiber composite wings can be molded by four methods.

The first is a hand lay-up molding process. This process is advantageous in its small equipment investment and good product appearance, but also has the following defects: 1. solvents evaporate, polluting environment and endangering health; 2. the bonding force between fiber material layers is small, and product strength is not sufficient; 3. the manufacturing process is relatively long.

The second is resin transfer molding (RTM), which is a process for injecting resin into a closed die such that reinforcement materials are infiltrated and cured. This process overcomes the effects of solvent evaporation into environment, but also has the following problems at present: 1. the bonding force between fiber material layers is small, and product strength is not sufficient; 2. investments in dies and equipment are required.

The third is a compression molding process which can well improve an inter-layer bonding force of products to obtain high-strength products. This process has the following defects: 1. a pre-formed core material is required and added in a middle during molding, Balsa wood or a PU block is usually adopted as the core material; 2. extra investment is needed for the pre-forming of the core material, increasing procedures and cost; 3. the PU block core material has a problem of shrinking after being heated, affecting the product strength; 4. the reject ratio of the product appearance is relatively high.

The fourth is inflation compression molding. A nylon air pipe is clad during product pre-forming. The nylon air pipe is inflated with air during compression molding such that the obtained product is full of mold cavities, and after resin is cured, a die can be opened to take out the product. This process has a problem which is difficult to solve: due to air leakage of the nylon air pipe, 2%-5% of rejected products are generated. Besides, the reject ratio of the product appearance is also relatively high, and the product appearance needs to be repaired, thus increasing cost.

### BRIEF SUMMARY OF THE DISCLOSURE

The objective of the disclosure is to provide an application of an HSM process in wing molding and a method for molding a light and smooth wing with high strength and with a streamlined shape. The molding method can reduce the use of fiber materials, lower cost, and ensure continuous batch production. To achieve the above objectives, the disclosure provides an application of an HSM process in wing molding.

The application includes the following steps:

cutting: cutting a core-type thermal expansion compound, a cladding-type thermal expansion compound and a fiber pre-preg fabric according to the shape and dimensions of a wing;

pre-forming a coiled product: cladding the core-type thermal expansion compound with the cladding-type thermal expansion compound, then cladding the fiber pre-preg fabric on the cladding-type thermal expansion compound;

molding: placing a pre-formed product in a wing die, closing a die cover, and heating the die such that the fiber pre-preg fabric is cured at a high temperature, where the thermal expansion HSM compound is expanded by the effect of a heating program, and then wing molding is completed;

cooling and de-molding: cooling the molding die to a reasonable temperature after molding, opening the die, and taking out the wing.

Further, the core-type thermal expansion compound refers to a thermosetting expansion composite sheet which expands in a certain temperature range, and after expanding, the core-type thermal expansion compound serves as a filled supporting core material and achieves an effect of enhancing the wing strength, where expansion occurs at a temperature within the range of 60-230° C., expansion power is 1-50 times, and the pressure generated after expansion is within the range of 0.1-20 MPa; the core-type thermal expansion compound expands at its expansion temperature and generates a pressure from the inside to the outside, and limited by an external die, the compound is cured and molded according to the die shape.

Optionally, the cladding-type thermal expansion compound refers to a thermoplasticity expansion composite sheet which expands in a certain temperature range, the compound achieves an effect of filling gaps after expanding, and finally, a smooth and streamline-shaped wing appearance is obtained, where expansion occurs at a temperature within the range of 60-230° C., the expansion power is 1-50 times, and the pressure generated after expansion is within the range of 0.1-20 MPa. The cladding-type thermal expansion compound expands at the expansion temperature and generates a pressure from the inside to the outside. Under the condition of maintaining a high-temperature and high-pressure internal environment, the cladding-type thermal expansion compound with thermoplasticity performance has high mobility and can well fill in step gaps at an edge of the core material-type thermal expansion compound, so the most outside fiber fabric is uniformly stressed and obtains a streamline-shaped appearance.

Optionally, the fiber pre-preg fabric is a carbon fiber pre-preg fabric or a glass fiber pre-preg fabric.

Further, in the molding step, the die is heated such that the pre-preg fabric is cured, where heating temperature is within the range of 100-240° C., and heating time is within the range of 10-120 min, ensuring that the resin is completely cured and reaches the optimal curing mechanical property.

Further, in the cooling and de-molding step, the temperature drop rate is within a range of 10° C./min-50° C./min during the cooling operation, and the temperature is reduced to be within a range of 15-100° C.

Besides, the disclosure also provides another wing molding method which is characterized by including the following steps:

cutting: cutting a core-type thermal expansion compound, a cladding-type thermal expansion compound and a fiber pre-preg fabric according to the shape and dimensions of a wing;

pre-forming a coiled product: cladding the core-type thermal expansion compound with the cladding-type thermal expansion compound, then cladding the fiber pre-preg fabric on the cladding-type thermal expansion compound;

molding: placing a pre-formed product in a wing die, closing a die cover, and heating the die such that the fiber pre-preg fabric is cured at a high temperature, where the thermal expansion compound is molded by the effect of a heating program (HSM process), and then wing molding is completed;

cooling and de-molding: cooling the molding die to a reasonable temperature after molding, opening the die, and taking out the wing.

Further, the core-type thermal expansion compound refers to a thermosetting expansion composite sheet which expands in a certain temperature range, and after expanding, the core-type thermal expansion compound serves as a filled supporting core material and achieves an effect of enhancing the wing strength, where expansion occurs at a temperature within the range of 60-230° C., expansion power is 1-50 times, and the pressure generated after expansion is within the range of 0.1-20 MPa;

optionally, the cladding-type thermal expansion compound refers to a thermoplasticity expansion composite sheet which expands in a certain temperature range, the compound achieves an effect of filling gaps after expanding, and finally, a smooth and streamline-shaped wing appearance is obtained, where expansion occurs at a temperature within the range of 60-230° C., expansion power is 1-50 times, and the pressure generated after expansion is within the range of 0.1-20 MPa;

optionally, the fiber pre-preg fabric is a carbon fiber pre-preg fabric or a glass fiber pre-preg fabric.

Further, in the molding step, the die heating temperature and the curing temperature of the pre-preg fabric are within the range of 100-240° C., and =heating time is within the range of 10-120 min.

Further, in the cooling and de-molding step, the temperature drop rate is within the range of 10° C./min-50° C./min during the cooling operation, and the temperature is reduced to be within a range of 15-100° C.

The disclosure also provides wings manufactured by using the wing molding method.

The HSM (Heat Self Molding) process refers to thermal expansion compound expanding when a thermal expansion compound is heated to expand and generate a pressure in a closed die cavity within the range of expansion temperature, and then the fiber pre-preg fabric, which receives the pressure from the inside to the outside, extends to fill in the whole die cavity, and then is cured and finalized.

The disclosure has the following beneficial effects:

1. The bonding force between the fiber layers is enhanced (materials of all layers are extruded by an expansion force of the thermal expansion compound, and the structure is more compact, so the bonding force is higher and the strength is enhanced). Light wing products with high strength are obtained.

2. The thermal expansion compound material filled inside ensures strength and reduces the use of the fiber materials, thus reducing cost.

3. Smooth wings with a streamlined shape are obtained.

4. The process can ensure continuous batch production, greatly improving the productivity.

The disclosure adopts two types of thermal expansion compounds with different functions, and clads the core material-type thermal expansion compound with the cladding-type thermal expansion compound, thus obtaining a mellow and smooth wing appearance. Only one thermal expansion compound is adopted in the prior art, for example, multiple layers of the thermal expansion compounds are superimposed to form the core material, and after expansion, edges of all layers form irremovable step traces, finally causing rough wing appearance and affecting use.

The disclosure adopts two types of thermal expansion compounds, where the core material-type thermal expansion compound is a thermosetting expansion composite sheet, for example, HR-320, HR-312-W, HR-318 or HR-330 produced by Xiamen Hower New Materials Ltd., and the cladding-type thermal expansion compound a is thermoplasticity expansion composite sheet, for example, HR-313 produced by Xiamen Hower New Materials Ltd.

### BRIEF DESCRIPTION OF THE SEVERAL VIEWS OF THE DRAWINGS

The sole FIGURE is a structural view of the disclosure.

### DETAILED DESCRIPTION OF THE DISCLOSURE

The embodiments of the disclosure are described in detail below. The examples of the embodiments are shown in the Sole FIGURE, wherein the same or similar marks always represent the same or similar elements or elements with the same or similar functions. The embodiments depicted by the attached drawings are exemplary, used to explain the disclosure only, and cannot be regarded as a limit to the disclosure. Unspecified technologies or conditions in the embodiments are subject to the technologies or conditions as described in the literature in the prior art or product manuals. All reagents or instruments without markings from manufacturers are all commercially available conventional products.

A wing molding method includes the following steps:

cutting: cutting a core-type thermal expansion compound, a cladding-type thermal expansion compound and a fiber pre-preg fabric according to the shape and dimensions of a wing;

pre-forming a coiled product: cladding the core-type thermal expansion compound with the cladding-type thermal expansion compound, then cladding the fiber pre-preg fabric on the cladding-type thermal expansion compound;

molding: placing a pre-formed product in a wing die, closing a die cover, and heating the die, where the thermal expansion compound is molded by the effect of a heating program (HSM process) while the fiber pre-preg fabric is cured at a high temperature, and then wing molding is completed;

cooling and de-molding: cooling the molding die to a reasonable temperature after molding, opening the die, and taking out the wing.

In the method, the core-type thermal expansion compound refers to a thermosetting expansion composite which expands in a certain temperature range, and after expanding, the core-type thermal expansion compound serves as a filled supporting core material and achieves an effect of enhancing wing strength, where expansion occurs at a temperature within a range of 60-230° C., expansion power is 1-50 times, and the pressure generated after expansion is within the range of 0.1-20M Pa.

Optionally, the cladding-type thermal expansion compound refers to a thermoplasticity expansion composite which expands in a certain temperature range, the compound with the high-temperature thermoplasticity property works with the core-type thermal expansion compound to achieve an effect of filling gaps after expanding, and finally, a smooth and streamline-shaped wing appearance is obtained, where expansion occurs at a temperature within the range of 60-230° C., expansion power is 1-50 times, and the pressure generated after expansion is within the range of 0.1-20 MPa.

Optionally, the fiber pre-preg fabric is a carbon fiber pre-preg fabric or a glass fiber pre-preg fabric.

Further, in the molding step, the die heating temperature and the curing temperature of the pre-preg fabric are within the range of 100-240° C., and the heating time is within the range of 10-120 min.

Further, in the cooling and de-molding step, the temperature drop rate is within the range of 10° C./min-50° C./min during the cooling operation, and the temperature is reduced to be within the range of 15-100° C.

In the following embodiments, the core material-type thermal expansion compound is a thermosetting expansion composite sheet, for example, HR-320, HR-312-W, HR-318 or HR-330 produced by Xiamen Hower New Materials Ltd., and the cladding-type thermal expansion compound is a thermoplasticity expansion composite sheet, for example, HR-313 produced by Xiamen Hower New Materials Ltd.

### Embodiment 1: Wing Molding Method

Cutting: cutting a core-type thermal expansion compound, a cladding-type thermal expansion compound and a carbon fiber pre-preg fabric according to the shape and dimensions of a wing;

pre-forming a coiled product: cladding the core-type thermal expansion compound with the cladding-type thermal expansion compound, then cladding the carbon fiber pre-preg fabric on the cladding-type thermal expansion compound;

molding: placing a pre-formed product in a wing die, closing a die cover, and heating the die (the temperature is 100° C., and the time is 120 min) such that the carbon fiber pre-preg fabric is cured at a high temperature (the temperature is 100° C., and the time is 120 min), where the thermal expansion compound is molded by the effect of a heating program (HSM process), and then wing molding is completed;

cooling and de-molding: cooling the molding die to a reasonable temperature after molding, opening the die, and taking out the wing.

The core material-type thermal expansion compound is a thermosetting expansion composite sheet, namely HR-318 produced by Xiamen Hower New Materials Ltd., and the cladding-type thermal expansion compound is a thermoplasticity expansion composite sheet, namely HR-313 produced by Xiamen Hower New Materials Ltd.

The obtained wing is light and smooth, and has high strength and a streamlined shape.

### Embodiment 2: Wing Molding Method

Cutting: cutting a core-type thermal expansion compound, a cladding-type thermal expansion compound and a glass fiber pre-preg fabric according to the shape and dimensions of a wing;

pre-forming a coiled product: cladding the core-type thermal expansion compound with the cladding-type thermal expansion compound, then cladding the glass fiber pre-preg fabric on the cladding-type thermal expansion compound;

molding: placing a pre-formed product in a wing die, closing the die cover, and heating the die (the temperature is 100° C., and the time is 120 min) such that the glass fiber pre-preg fabric is cured at a high temperature (the temperature is 240° C., and the time is 10 min), where a thermal expansion HSM compound is molded by the effect of a heating program, and then wing molding is completed;

cooling and de-molding: cooling the molding die to 100° C. after molding (temperature drop rate:50° C./min), opening the die, and taking out the wing.

The core material-type thermal expansion compound is a thermosetting expansion composite sheet, namely HR-320 produced by Xiamen Hower New Materials Ltd., and the cladding-type thermal expansion compound is a thermoplasticity expansion composite sheet, namely HR-313 produced by Xiamen Hower New Materials Ltd.

The obtained wing is light and smooth, and has high strength and a streamlined shape.

### Embodiment 3: Wing Molding Method

Cutting: cutting a core-type thermal expansion compound, a cladding-type thermal expansion compound and a glass fiber pre-preg fabric according to the shape and dimensions of a wing;

pre-forming a coiled product: cladding the core-type thermal expansion compound with the cladding-type thermal expansion compound, then cladding the glass fiber pre-preg fabric on the cladding-type thermal expansion compound;

molding: placing a pre-formed product in a wing die, closing a die cover, and heating the die (the temperature is 100° C., and the time is 120 min) such that the glass fiber pre-preg fabric is cured at a high temperature (the temperature is 180° C., and the time is 60 min), where the thermal expansion compound is molded by the effect of a heating program (HSM process), and then wing molding is completed;

cooling and de-molding: cooling the molding die to 50° C. after molding (temperature drop rate:30° C./min), opening the die, and taking out the wing.

The core material-type thermal expansion compound is a thermosetting expansion composite sheet, namely HR-312-W produced by Xiamen Hower New Materials Ltd., and the cladding-type thermal expansion compound is a thermoplasticity expansion composite sheet, namely HR-313 produced by Xiamen Hower New Materials Ltd.

The obtained wing is light and smooth, and has high strength and a streamlined shape.

### Embodiment 4: Wing Molding Method

Cutting: cutting a core-type thermal expansion compound, a cladding-type thermal expansion compound and a glass fiber pre-preg fabric according to the shape and dimensions of a wing;

pre-forming a coiled product: cladding the core-type thermal expansion compound with the cladding-type thermal expansion compound, then cladding the glass fiber pre-preg fabric on the cladding-type thermal expansion compound;

molding: placing a pre-formed product in a wing die, closing a die cover, and heating the die (the temperature is 100° C., and the time is 120 min) such that the glass fiber pre-preg fabric is cured at a high temperature (the temperature is 200° C., and the time is 80 min), where the thermal expansion compound is molded by the effect of a heating program (HSM process), and then wing molding is completed;

cooling and de-molding: cooling the molding die to 60° C. after molding (temperature drop rate:40° C./min), opening the die, and taking out the wing.

The core material-type thermal expansion compound is a thermosetting expansion composite sheet, namely HR-330 produced by Xiamen Hower New Materials Ltd., and the cladding-type thermal expansion compound is a thermoplasticity expansion composite sheet, namely HR-313 produced by Xiamen Hower New Materials Ltd.

The obtained wing is light and smooth, and has high strength and a streamlined shape.

The embodiments of the disclosure are shown and described above, but it should be understood that the above embodiments are used as examples and cannot be regarded as the limit in the disclosure. Those ordinarily skilled in this field can make changes, amendments, replacement and modifications on the above embodiments within the scope of the disclosure.

What is claimed is:

1. An application of an HSM (Heat Self Molding) process to wing molding.

2. The application of an HSM process to wing molding according to claim 1, wherein a specific application comprises the following steps:
cutting: cutting a core-type thermal expansion compound, a cladding-type thermal expansion compound and a fiber pre-preg fabric according to the shape and dimensions of a wing;
pre-forming a coiled product: cladding the core-type thermal expansion compound with the cladding-type thermal expansion compound, then cladding the fiber pre-preg fabric on the cladding-type thermal expansion compound;
molding: placing a pre-formed product in a wing die, closing a die cover, and heating the die, wherein the thermal expansion compound is molded by the effect of a heating program (HSM process) while the fiber pre-preg fabric is cured at a high temperature, and then wing molding is completed;
cooling and de-molding: cooling the molding die to a reasonable temperature after molding, opening the die, and taking out the wing.

3. The application of an HSM process to wing molding according to claim 2, wherein the core-type thermal expansion compound refers to a thermosetting expansion composite sheet which expands within a certain temperature range, and after expanding, the core-type thermal expansion compound serves as a filled supporting core material and achieves an effect of enhancing the wing strength, wherein expansion occurs at a temperature within the range of 60-230° C., expansion power is 1-50 times, and the pressure generated after expansion is in a range of 0.1-20M Pa;
optionally, the cladding-type thermal expansion compound refers to a thermoplasticity expansion composite sheet which expands in a certain temperature range, the compound achieves an effect of filling gaps after expanding, and finally, a smooth and streamline-shaped wing appearance is obtained, wherein expansion occurs at a temperature within a range of 60-230° C., expansion power is 1-50 times, and the pressure generated after expansion is within a range of 0.1-20 MPa;
optionally, the fiber pre-preg fabric is a carbon fiber pre-preg fabric or a glass fiber pre-preg fabric.

4. The application of an HSM process to wing molding according to claim 2, wherein in the molding step, the die is heated such that the pre-preg fabric is cured, wherein the heating temperature is 100-240° C., and the heating time is 10-120 min.

5. The application of an HSM process to wing molding according to claim 2, wherein in the cooling and de-molding step, the temperature drop rate is within the range of 10° C./min-50° C./min during the cooling operation, and the temperature is reduced to be within the range of 15-100° C.

6. A wing molding method, comprising the following steps:
cutting: cutting a core-type thermal expansion compound, a cladding-type thermal expansion compound and a fiber pre-preg fabric according to the shape and dimensions of a wing;
pre-forming a coiled product: cladding the core-type thermal expansion compound with the cladding-type thermal expansion compound, then cladding the fiber pre-preg fabric on the cladding-type thermal expansion compound;
molding: placing a pre-formed product in a wing die, closing a die cover, and heating the die, wherein the thermal expansion compound is molded by the effect of a heating program (HSM process) while the fiber pre-preg fabric is cured at a high temperature, and then wing molding is completed;
cooling and de-molding: cooling the molding die to a reasonable temperature after molding, opening the die, and taking out the wing.

7. The wing molding method according to claim 6, wherein the core-type thermal expansion compound refers to a thermosetting expansion composite sheet which expands in a certain temperature range, and after expansion, the core-type thermal expansion compound serves as a filled supporting core material and achieves the effect of enhancing the wing strength, wherein expansion occurs at a temperature within the range of 60-230° C., expansion power is 1-50 times, and the pressure generated after expansion is in a range of 0.1-20 MPa;
optionally, the cladding-type thermal expansion compound refers to a thermoplasticity expansion composite sheet which expands in a certain temperature range, the compound achieves an effect of filling gaps after expanding, and finally, a smooth and streamline-shaped wing appearance is obtained, wherein expansion occurs at a temperature within the range of 60-230° C., expansion power is 1-50 times, and the pressure generated after expansion is within the range of 0.1-20 MPa;
optionally, the fiber pre-preg fabric is a carbon fiber pre-preg fabric or a glass fiber pre-preg fabric.

8. The wing molding method according to claim 6, wherein in the molding step, the die is heated such that the pre-preg fabric is cured, wherein the heating temperature is 100-240° C., and the heating time is 10-120 min.

9. The wing molding method according to claim 2, wherein in the cooling and de-molding step, the temperature drop rate is within the range of 10° C./min-50° C./min during the cooling operation, and the temperature is reduced to be within the range of 15-100° C.

10. A wing prepared by using the wing molding method according to claim 6.
